(19) United States
(12) Patent Application Publication
(10) Pub. No.: US 2002/0022390 A1
(43) Pub. Date: Feb. 21, 2002

(54) Device for establishing an electrical plug-in connection

(76) Inventors: Thomas Duerbaum, Langerwehe (DE); Juergen Halfmann, Buehlertal (DE)

Correspondence Address: U.S. Philips Corporation, 580 White Plains Road, Tarrytown, NY, 10591, US

(21) Appl. No.: 09/918,161

(22) Filed: Jul. 30, 2001

(30) Foreign Application Priority Data
Aug. 2, 2000 (DE) 10037553.7

(51) Int. Cl. H01R 13/44

(52) U.S. Cl. 439/130

(57) ABSTRACT

A device for establishing an electrical plug-in connection to a socket, which device has a housing body and at least one plug pin for plugging into the socket, which plug pin, in a first position, projects from the housing body, is improved so that the whole device needs less space. For this purpose, it is provided that the plug pin can be moved into a second retracted position in which it projects less far from the housing body. For example, in a plug-in power supply the contact pins can be arranged in a folding manner, so that the whole device needs less space.

The invention relates to a device for establishing an electrical plug-in connection to a socket, and a plug-in power supply.

Electrical plug-in connections are used for a large number of appliances. More particularly, for the power supply to electrical appliances, for example, notebook computers, mobile telephones and so on, plug devices are used i.e. devices in which the plug in this case consisting of two plug pins is provided on a housing body itself. For example, in a plug-in power supply is installed a complete power supply i.e. customarily transformers, rectifiers and so on, directly in the plug housing.

As with all electronic appliances, also for such plug devices, more particularly, plug-in power supplies, there is a wish to manufacture them ever smaller.

Therefore, it is an object of the invention to further develop the known devices, so that they take up less space.

This object is achieved by a device having the characteristic features of claim 1. Dependent claims relate to advantageous embodiments.

The invention is based on the recognition that the projecting plug contacts (for example, two plug pins of a Eurostandard plug for electricity power grid sockets) already largely have the design and, more particularly, the overall size of the plug. This also holds for simple plugs in which the housing body only consists of a plug housing to which a cord is connected. More particularly, this has an effect on plug devices in which already the device—for example, a power supply—is accommodated inside the housing body. The invention takes into account that the projecting plug contacts, however, are not necessary as long as the device is not in function, that is to say, as long as the plug is not plugged into the socket.

Therefore, according to the invention there is provided that the plug contact moves from the projecting first position into a second position, for example, can be folded up or slid inwards, in which position it projects less far from the housing body.

When a respective plug or such a plug device, respectively, is not used, that is to say, is not plugged into the socket, the plug contact(s) can be brought to the second (retracted) position. The device then has accordingly smaller dimensions, so that transport and storage are simplified.

The plug contact in the second position is preferably at least partly withdrawn into the housing body. However, it may also be sufficient to fold back the plug contact only as far as the housing, so that it projects over a smaller distance.

According to a further embodiment of the invention, the plug contact—in a conventional electricity power supply plug the two plug pins—can be folded back between the first and the second position. If there are more plug pins, they may be folded back individually. It is alternatively possible for the contacts to be arranged on a common front portion, which is foldably attached to the housing, so that the two plug pins are folded back in common.

By folding the plug contact back, it can be positioned against the housing, so that all in all a smaller plug arises. Also a respective deepening, for example, a depression, may be provided on the housing, so that the folded plug contact is totally or partly withdrawn into the housing body and no longer projects.

Advantageously, the plug contact can be locked in its first position. Only after this special lock is released can it be moved to the second, withdrawn, position. In this manner sufficient functionality is guaranteed, so that the plug contact does not fold back of its own accord, or is slid inwards when it is to be plugged into a socket.

The locking may be achieved with the aid of many locking mechanisms known to the expert, among which, for example, movable mechanical locking elements, or locking mechanisms. A locking is preferred that can be released by pulling the plug contact in the direction away from the housing body. Additional actuation elements may then be omitted. It is highly advantageous when the plug contact is kept in the locked position with a given retaining force (which may be provided, for example, by a spring) against the pulling out (and thus release), while the retaining force is smaller than the friction force that occurs when the plug contact is pulled out of the socket. This enables an automatic unlocking or folding back; when the plug is pulled out of the socket, the friction of the plug contact and the socket influences the plug contact in the direction away from the housing, thus in the unlock direction. This automatically provides the release of the lock when the plug contact is removed. If, for example, the folding mechanism is spring-loaded, the plug contact is automatically folded back.

Another possibility of moving the plug contact between the two positions is making the contacts slidable. For example, the plug contact may be arranged so that it can be led out of the housing in its longitudinal direction (first position) when the plug is to be used and, accordingly, be completely or partly retracted into the housing (second position) when the plug is not used. Inside the housing a respective guide in the form of a slot may be provided. For example, with an electricity power supply plug the two plug contacts may be connected to a (an insulating) bridge and collectively guided into a slot, so that they can always be pushed in and out together.

These and other aspects of the invention are apparent from and will be elucidated with reference to the embodiments described hereinafter.

In the drawings:

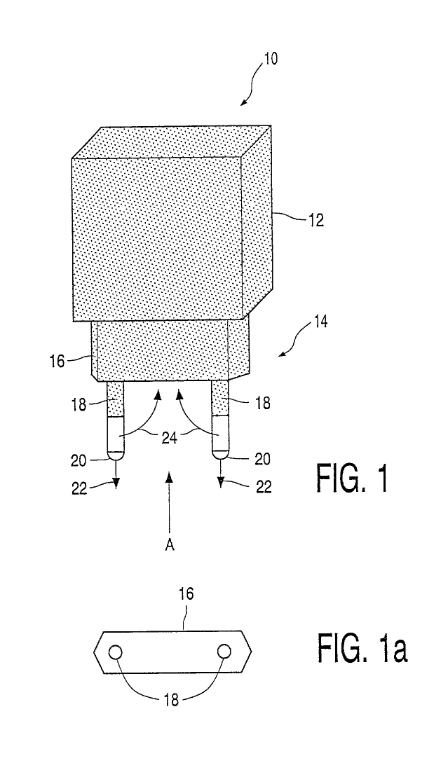

FIG. 1 shows a front elevation of a first embodiment of a plug housing with folded-out plug pins;

FIG. 1a shows an elevation of the first embodiment of a plug housing in the direction of arrow A of FIG. 1;

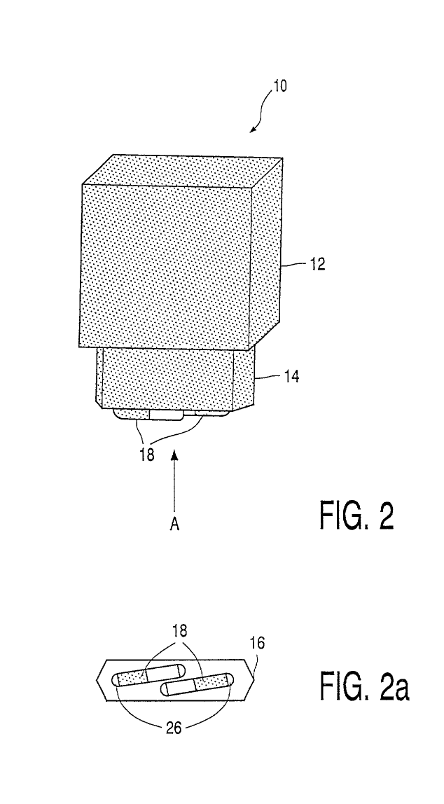

FIG. 2 shows a front elevation of the first embodiment of a plug housing of FIG. 1 with folded-back plug pins;

FIG. 2a shows an elevation of the first embodiment of a plug housing of FIG. 2 in the direction of the arrow A;

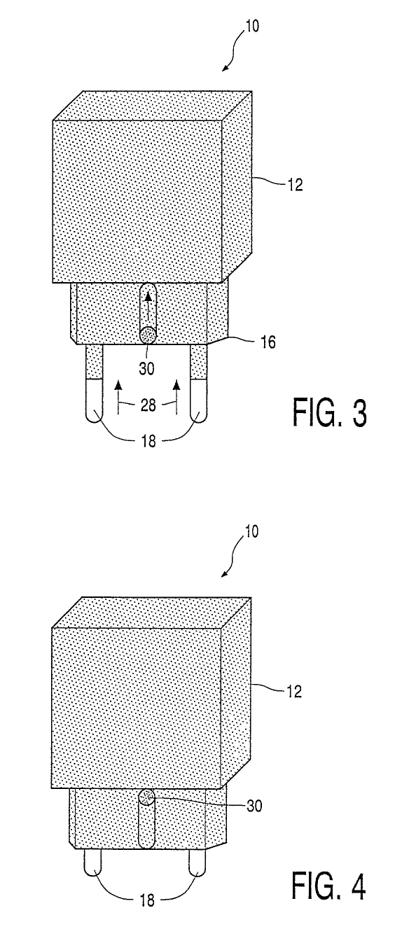

FIG. 3 shows a front elevation of a second embodiment of a plug housing with pushed-out plug pins;

FIG. 4 shows a front elevation of the second embodiment of the plug housing with pushed-in plug pins.

FIG. 1 shows a plug device 10 which comprises a housing 12 with a directly connected plug part 14. The plug part 14 comprises a plug front part 16 from which two plug pins 18 project.

The plug device 10 is, for example, a plug-in power supply. The plug-in power supply is plugged with the plug part 14 into a socket of the electricity power grid. For this purpose the projecting plug pins 18 are plugged into the female contacts of the socket (not shown), so that contacts 20 of the plug pins 18 form an electrical contact with the female contacts of the socket. The housing 12 comprises a power supply i.e. a voltage transformer and—depending on the application—further electronics, for example, rectifiers, smoothing capacitors and voltage regulators.

The position of the plug pins 18 is also clear from FIG. 1a. The plug pins 18 in their longitudinal direction project in line with the housing 12 of the plug device 10.

The plug pins 18 in the first embodiment shown are foldable. For folding the plug pins 18 back from the first position shown in FIGS. 1 and 1a, first the lock is to be released. A locking mechanism (not shown) is provided, so that the plug pins 18 in the first position shown in FIG. 1 cannot readily be folded.

The plug pins 18 can be axially moved in their longitudinal direction. However, a spring is provided that exerts a retention force on the plug pins, so that they continue to be in the locked position when not a large force is applied to them.

For releasing the lock, the two plug pins 18 are pulled out against the spring force in the direction of the arrows 22, thus in their longitudinal direction from the housing 12. After that the folding mechanism is unlocked and the plug pins 18 can be folded back to the housing 12 in the direction of the arrows 24.

Each contact pin can individually be folded back by hand in that the contact pin is pulled out (unlocked) and then folded back. In the embodiment shown the contact pins 18, however, are folded back automatically when the plug is removed from the socket.

When the plug portion 14 is accommodated in the socket, the contacts 20 are clamped by respective female contacts of the socket. When the plug portion 14 is pulled out of the socket, a retention force acts on the plug pins 18 and keeps them in the socket. If the housing 12 is removed from the socket, the plug pins 18 are first retained with a certain retaining force—depending on the friction between the contacts 20 and the female contact of the socket—and pulled out of the housing in this way.

The friction of the contacts 20 in the female contacts of the socket provides that the retaining force of the springs on the plug pins 18 in the locking position is conquered. The expert may simply provide that the automatic fold back functions for substantially all sockets. Even when the respective friction of socket to plug will be different, the expert can easily set the retaining force to such a low value that the value of the friction force will be higher for each socket that still satisfies the standard, but, on the other hand, the contact pins are not unlocked of their own accord.

The plug pins 18 are spring-loaded in folding direction 24, so that they automatically fold back after being unlocked.

The folded-back second position of the plug pins 18 is shown in FIG. 2. The plug pins 18 are folded back against the housing 12 where they rest in recesses (not shown) provided for this purpose in the plug front 14.

FIG. 2a shows how the plug pins 18 lie in the plug front 16 folded back into a joint 26 shown only symbolically.

A second embodiment of the invention is shown in FIGS. 3 and 4. FIG. 3 shows a plug device 10 comprising a housing 12 and directly attached plug front 16 with plug pins 18.

In this second embodiment the plug pins 18 can be stored slidably in the plug front 16. They can be inserted into the housing 12 in their longitudinal direction in the direction of the arrow 28, as is shown in FIG. 3.

Inside the housing 12 (not shown), a bridge of non-conductive material connects the two plug pins, so that they are pushed up only as a unit. This unit is located in a slotted guide (not shown either) so that the complete pushing movement is guided.

A sliding knob 30, which can be moved between the first position shown in FIG. 3 and the position shown in FIG. 4, is provided as a manual actuating means. The sliding knob 30 is then connected inside the housing to the unit formed by the two plug pins 18, so that when the sliding knob 30 is moved between the two positions shown, the plug pins are pulled into the housing.

The second position of the plug pins is shown in FIG. 4. Here the plug pins 18 are nearly completely pulled up in their longitudinal direction into the housing 12. The sliding knob 30 is shown in the second position.

The sliding knob 30 may have a locking mechanism by which it is to be locked in the two end positions shown, and is first to be released by pressing on it before it is slid up or down.

1. A device for establishing an electrical plug-in connection to a socket, comprising a housing body (12), and at least one plug pin (18) to be inserted into the socket, which plug pin (18) in a first position projects from the housing body (12), characterized in that the plug pin (18) can be moved to a second retracted position in which position it projects less far from the housing body (12).

2. A device as claimed in claim 1, in which the plug pin (18) in the second position is at least partly accommodated in the housing body (12).

3. A device as claimed in one of the preceding claims, in which two plug pins (18) are provided for being plugged into a socket of the electricity power grid.

4. A device as claimed in one of the preceding claims, in which the plug pin (18) can be folded back between the first and the second position.

5. A device as claimed in one of the preceding claims, in which the plug pin (18) is locked in the first position, so that it cannot be moved to the second position.

6. A device as claimed in one of the preceding claims, in which the lock can be released by pulling the plug pin (18) in a direction away from the housing body (12).

7. A device as claimed in claim 6, in which the contact pin (18) is kept in the locked position by a retaining force, in which the retaining force is smaller than the friction, in which pulling the plug pin (18) out of the socket influences the plug pin (18).

8. A device as claimed in one of the preceding claims, in which the plug pin (18) is slidable.

9. A device as claimed in claim 8, in which the plug pin (18) is moved in a guide.

10. A device as claimed in claim 9, in which two plug pins (18) are provided which are together moved in a guide and connected to a bridge.

11. A device as claimed in one of the preceding claims, in which the movement of the plug pin (18) between the first and the second position is made by a manual actuation means, more particularly, a push button and/or slide button (30).

12. A device as claimed in one of the preceding claims, in which the plug pin (18) is provided in a plug front (16) while the plug front (16), together with the plug pin (18) is foldably attached to the housing (12).

13. A plug-in power supply comprising a plug device (10) as claimed in one of the claims 1 to 11 and a power supply, in which the power supply is arranged inside the housing body (12).
